(19) United States
(12) Patent Application Publication
(10) Pub. No.: US 2008/0108446 A1
(43) Pub. Date: May 8, 2008

(54) Universal Joint

(76) Inventor: Dieter Faude, Gaertringen (DE)

Correspondence Address: JORDAN AND HAMBURG LLP, 122 EAST 42ND STREET, SUITE 4000, NEW YORK, NY, 10168, US

(21) Appl. No.: 11/795,221

(22) PCT Filed: Feb. 21, 2006
(86) PCT No.: PCT/DE06/00336

§ 371 Date: Sep. 10, 2007

(30) Foreign Application Priority Data
Feb. 22, 2005 (DE) 10 2005 009 286.1

(51) Int. Cl. F16D 3/00

(52) U.S. Cl. 464/136

(57) ABSTRACT

A universal joint includes a first joint fork having a joint axis and a second joint fork having a joint axis, the joint axes being borne by plain bearings and the joint forks each being formed by a base part and two fork elements. Each fork element has a closable bore, and the joint axes intersect between the bores, whereby a bearing prestress unit allows the joint fork to function without play about the joint axis thereof so that the universal joint can be positioned precisely.

### BACKGROUND OF THE INVENTION

The invention relates to a universal joint.

As a rule, such universal joints have a roller or plain bearing. However, it is disadvantageous that production-imposed tolerances can lead to distortions or that there can be too much play, which has a negative effect on the operational reliability of the bearing and on the accuracy of the universal joint and the positioning thereof.

Known from DE 44 39 998 A1 is a universal joint that, for connecting two joint forks, has a cross link assembly made of four journals, two journals being located on a common axis. Each axis is borne by means of a roller bearing on a bearing bush and has a spring element made of a high-strength plastic. A tolerance imposed by the assembly is supposed to be compensated using the spring element. However, the spring element also enables the journal in the bearing bush to yield so that the universal joint can no longer be positioned accurately.

### SUMMARY OF THE INVENTION

In contrast, the inventive universal joint has the advantage that a bearing prestress unit allows the joint forks to function without play about the joint axis thereof, thus making it possible to accurately position the universal joint. In addition, it is possible to reduce the stip slick effect by using newly developed materials.

The inventive universal joint can in particular be used with robots that are equipped with rod kinematics and that have a platform (Stuart platform) and that move a tool or other article that is arranged on the platform by means of an article holder in three dimensions corresponding to a prespecified program. Such automated units are used not only in inaccessible or dangerous spaces, but primarily also to replace manual human actions. The use of a plain bearing is advantageous because roller bearings that are used in general for such types of technologies have much lower bearing capacity compared to plain bearings, which provide a large bearing surface.

In accordance with one advantageous embodiment of the invention, the bearing prestress unit is formed at least by one spring element that acts on the joint axis.

In accordance with one advantageous embodiment of the invention in this regard, at least one of the bores is closed by a pressure plate that acts on the spring element. The inventive universal joint can be adjusted using the pressure plate.

In accordance with one advantageous embodiment of the invention in this regard, a spacer ring is arranged between the pressure plate and the base part. The inventive universal joint can be adjusted using this spacer ring.

In accordance with one additional advantageous embodiment of the invention, the spring element is a spring collar.

In accordance with one additional advantageous embodiment of the invention, a positioning block is arranged between the bores for positioning the joint axes.

In accordance with one advantageous embodiment of the invention in this regard, the joint axes are borne by a plain bearing in the positioning block.

In accordance with one additional advantageous embodiment of the invention, the joint axes are formed by one pin and two sleeves arranged perpendicular thereto.

In accordance with one advantageous embodiment of the invention in this regard, the joint axes are affixed to one another.

In accordance with one advantageous embodiment of the invention in this regard, this affixing is accomplished using a screw that can be inserted through the sleeves and a bore in the pin. This results in a cross pin.

In accordance with one additional advantageous embodiment of the invention, the base part has at least one fastening means on the side facing away from the fork elements.

Additional advantages and advantageous embodiments of the invention can be found in the following description, drawings, and claims.

Exemplary embodiments of the invention are depicted in the drawings and are described in greater detail in the following.

### BRIEF DESCRIPTION OF THE DRAWINGS

FIG. 1 is an exploded depiction of an inventive universal joint;

FIG. 2 is a top view of an inventive universal joint;

FIG. 3 is a side view of an inventive universal joint;

FIG. 4 is a side view of an inventive universal joint;

FIG. 5 is a view of an inventive universal joint in accordance with the section A-A from FIG. 3;

FIG. 6 is a view of an inventive universal joint in accordance with the section B-B from FIG. 3;

FIG. 7 is a detailed perspective view of a cross pin and a view of the cross pin in accordance with the section A-A from FIG. 3;

FIG. 8 is a detailed perspective view of a cross pin and a view of the cross pin in accordance with the section A-A from FIG. 3, in a modified form;

FIG. 9 is a detailed perspective view of a cross pin and a view of the cross pin in accordance with the section A-A from FIG. 3, in another modified form;

FIG. 10 is a perspective view of a positioning block and sectional drawings of the positioning block;

FIG. 11 is a perspective view and a view of a joint fork with installed positioning block;

FIG. 12 is a view of an inventive universal joint in accordance with the section B-B from FIG. 3 and a detailed view of a first variant of the installed placement of the positioning block;

FIG. 13 is a view of an inventive universal joint in accordance with the section B-B from FIG. 3 and a detailed view of a second variant of the installed placement of the positioning block;

FIG. 14 is a view of an inventive universal joint in accordance with the section B-B from FIG. 3 and a detailed view of a third variant of the installed placement of the positioning block;

FIG. 15 is a view of an inventive universal joint in accordance with the section B-B from FIG. 3 and a detailed view of a radial bearing of the pin in the joint eyes;

FIG. 16 is a variant of the embodiment of the bearing ring (spring collar 15) in sectional drawings; and,

FIG. 17 is a view of an inventive universal joint 1 in accordance with the section B-B from FIG. 3 and a detailed view of a modified radial bearing.

### DESCRIPTION OF THE PREFERRED EMBODIMENTS

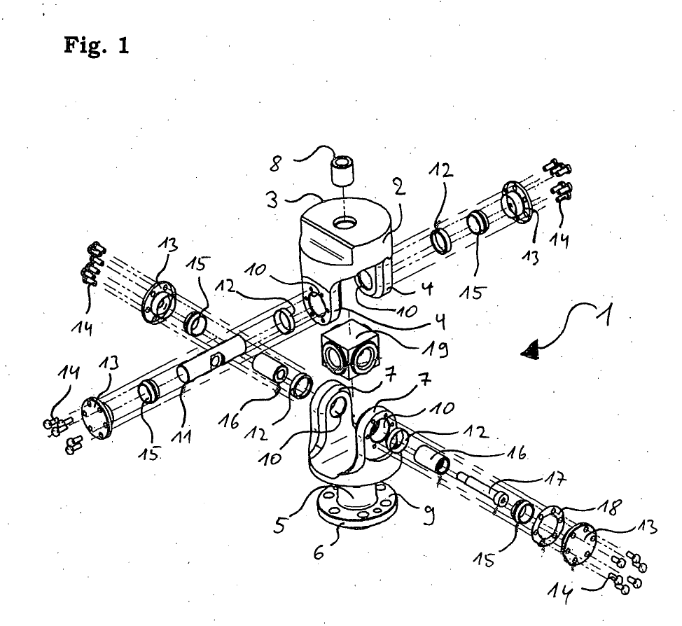

FIG. 1 is an exploded depiction of an inventive universal joint 1. It comprises a first joint fork 2, which constitutes a base part 3 and two fork elements 4, and a second joint fork 5, which constitutes a base part 6 and two fork elements 7. The base part 3 has a threaded insert 8 and acts for instance as a connecting part for a Stuart plate (not shown). It can have a hard-coated surface plain bearing and ground interior sides and is a bearing element for the entire bearing. The base part 6 has a flange 9 and acts for instance as an interface to different materials e.g. a carbon tube (not shown). If there is wear or if the inventive universal joint 1 is destroyed, it is possible to exchange it easily using the base parts 3 and 6. The fork elements 4 and 7 each have bores 10 in their joint axes. The joint axis of the first joint fork 2 is formed by a pin 11 that is borne in the bores 10 of the first joint fork 2 by bearing rings 12 (plain bearings). These bearing rings 12 have an exterior geometry that is ground conically on two sides (exterior ring). The interior diameter is reduced or prestressed by a cone effect.

The bores 10 are each closed by a pressure plate 13 and are connected to the fork element 4 by means of screws 14 (cylinder screws, torx, hex socket screws, or the like), the pressure plates 13 exerting pressure on the pins 11 via the spring collars 15. The pressure plates 13 are intended to transmit the bearing prestress to the bearing rings 12. At the same time, the pressure plates 13 contain an anti-rotation element for the plain bearing. With the pressure plate 13, the exterior ring of the spring collar 15 forms the bearing prestress unit and the bearing housing.

Arranged perpendicular to the pin 11 are two sleeves 16 that are screwed to the pin 11 by means of a screw 17, for instance a fitted screw machined on its head, and that form the joint axis of the second joint fork 5. The joint axis of the second joint fork 5 is also borne by bearing rings 12 (plain bearings). The bores 10 are each closed by a pressure plate 13 and are connected to the fork unit 7 by means of screws (cylinder screws, torx, hex socket screws, or the like), the pressure plates 13 exerting pressure on the sleeves 16 via spring collars 15. Spacer rings 18 can be added or removed between the pressure plates 13 and the fork elements 4 and 7 for additional bearing prestress.

Screwing the sleeves 16 to the pin 11 forms a cross pin that has a very compact construction. The cross pin is easy to assemble and can also be disassembled without being destroyed.

Arranged centrally between the fork elements 4 and 7 at the point of intersection for the joint axes is a positioning block 19 that is produced from the same material as the bearing rings 12. The positioning block 19 forms the point of intersection for the universal joint axes with highly precise production and transmits the forces in the radial and axial directions and positions the axes relative to one another.

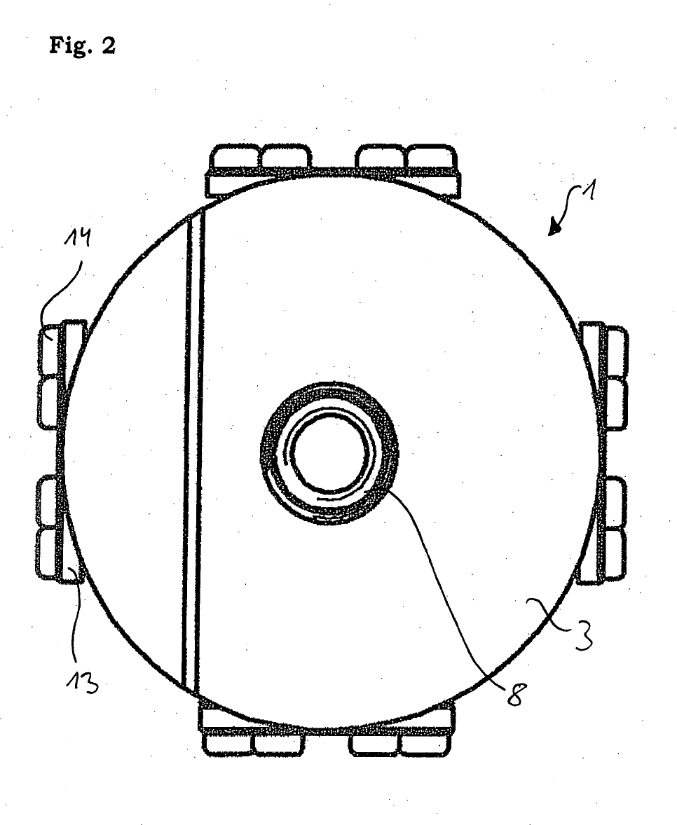

FIG. 2 depicts a top view of an assembled inventive universal joint 1 on the base part 6 with the threaded insert 8.

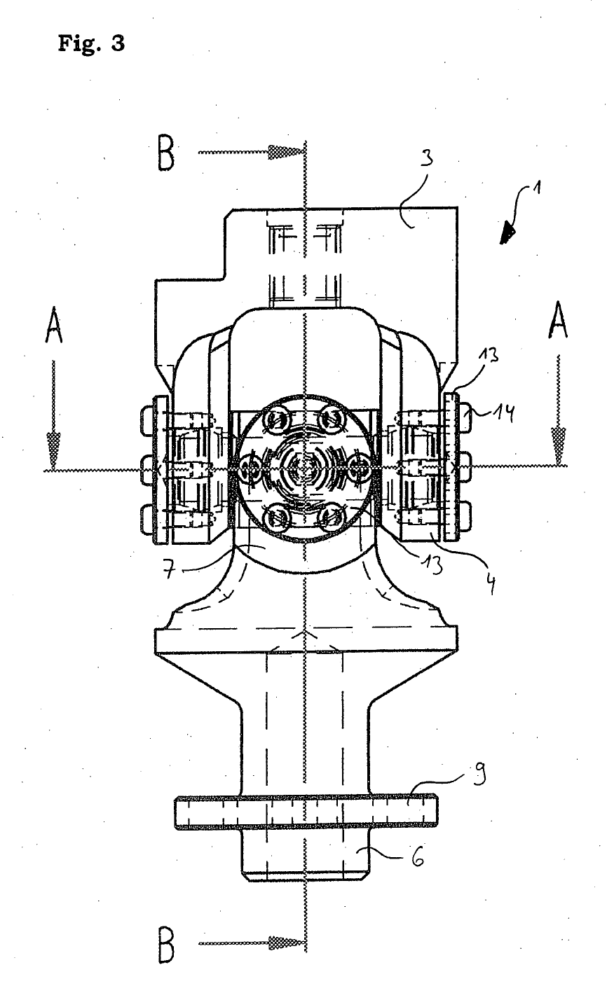

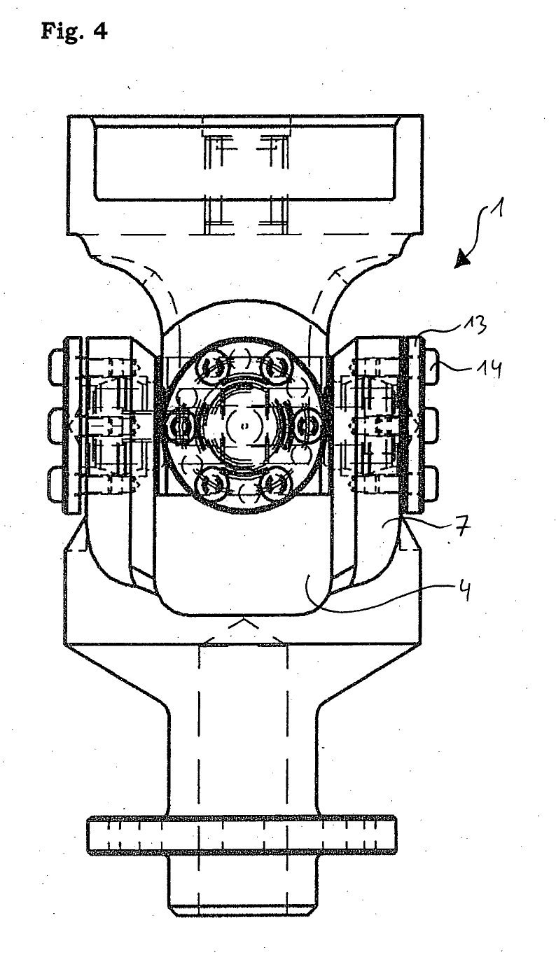

FIG. 3 and FIG. 4 each depict a side view of an inventive universal joint 1. The pressure plates 13 are affixed to the fork elements 4 and 7 by means of screws 14.

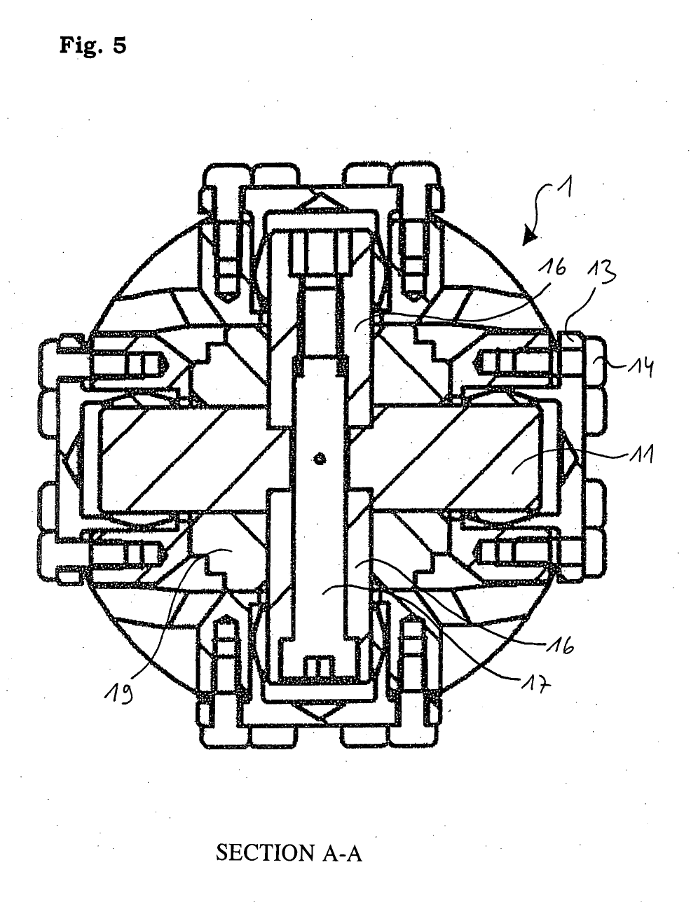

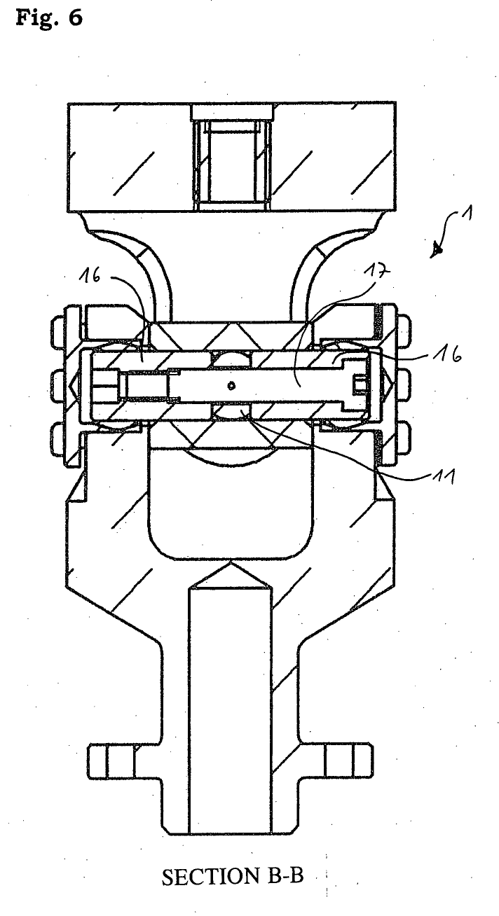

FIG. 5 depicts a view of an inventive universal joint 1 in accordance with section A-A from FIG. 3 and FIG. 6 depicts a view of an inventive universal joint 1 in accordance with the section B-B from FIG. 3. The sleeves 16 are secured to the pin 11 using the screw 17. The positioning block 19 is arranged at the point of intersection for the two joint axes.

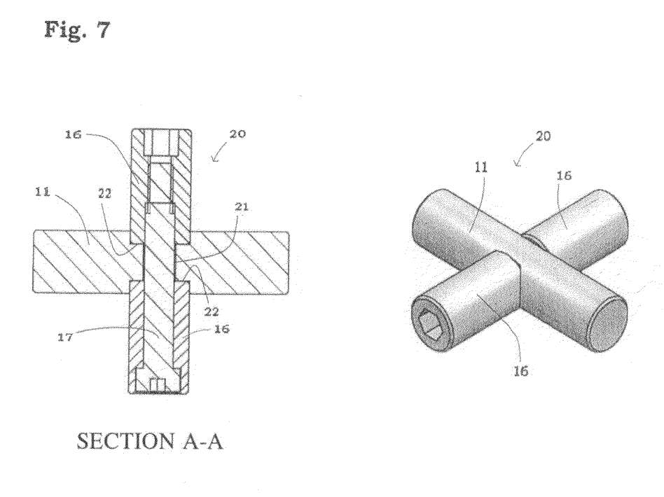

FIG. 7 is a detailed perspective view of a cross pin 20 and a view of the cross pin 20 in accordance with the section A-A from FIG. 3. The cross pin 20 is the core piece of the inventive universal joint 1. All forces are transmitted in it. Ideally the axes of the inventive universal joint 1 intersect one another precisely in the center. However, in practice this is not possible due to production tolerances. Therefore, normally the axis cross in a universal joint is produced from a solid body using the manufacturing methods that are consequently necessary and also cost intensive. Since the precise overlap of the axes in the center is not determined by the geometries of the individual parts of the cross pin 20, the individual parts can be produced with relatively rough tolerances. The cross pin 20 used in the inventive universal joint 1 is preferably cylindrical on all sides on all and is distinguished in particular by the following improvements:
1. Construction in parts, therefore significantly higher flexibility in terms of assembly;
2. Individual parts with surfaces that are geometrically simple to produce;
3. Great variety in terms of materials;
4. Great variety in terms of coatings;
5. Great positioning accuracy for individual axes not required; and
6. Wear parts can be exchanged individually.

Coating of the plain bearing and roller bearing surfaces is particularly important, especially for the individual parts of the universal joint pin 20 [possibly typographical error for Kreuzbolzen=cross pin] described herein. Appropriate oxide coating, nitride coating, or the like is existential [sic] for the wear resistance of the bearing unit. All combinations of PVD/CVD coatings or resin methods, as well as TIN, TIALN, CR/C, TICN, hard chrome, etc. are advantageous for the coatings.

High quality tool steel has proved to be an ideal material for producing the individual cross pin parts. The annealing temperature for these steels is greater than the temperature used during PVD coating. Thus the substrate properties are not affected or are affected only to a negligible degree. However, the use of totally ceramic materials, plastics, or other materials would also be conceivable.

The cross pin 20 depicted in FIG. 7 is produced as a through cylindrical body. A transverse bore 21, required and appropriately produced for the screw 17 (fitted axis screw), is located in the center. The outlet areas for the transverse bore 21 have corresponding recessed surfaces 22 for the contact surface of the sleeves 16 (joint sleeves). The sleeves 16 are screwed on by means of the screw 17 (standard part). In the guide or overlap areas of the fitted pin, the sleeves 16 are produced with correspondingly narrow interior tolerances. Thus a lower bending torque is transmitted to the threading of the fitted axis pin.

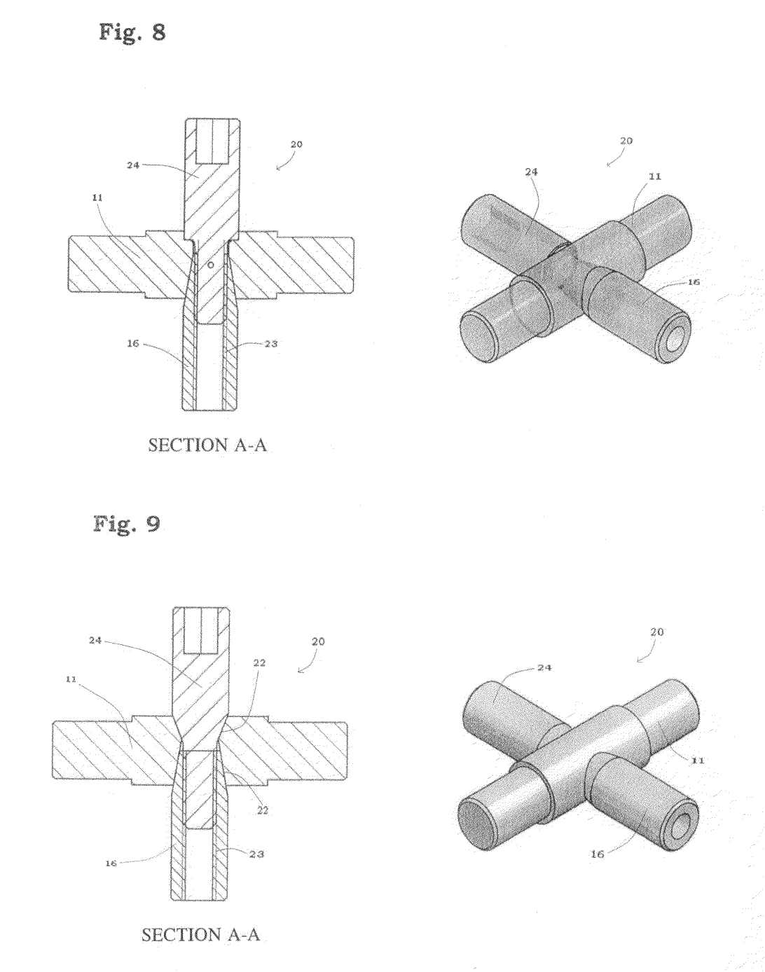

FIG. 8 is a detailed perspective view of a cross pin 20 and a view of the cross pin 20 in accordance with the section A-A from FIG. 3, in a modified form. It shows the structure of the cross pin 20, which can be taken apart, with offset pin 11 or sleeve. In this solution the bearing diameter can be varied without greatly affecting the basic stiffness of the cross pin 20. Moreover, the cross pin 20 can also be screwed together without a fitted axis screw. A thread 23 is added to the sleeve 16. The bolt 24 is screwed into this thread 23 through the pin 11. The advantage of this arrangement is that the pin connection is forced geometrically to the axis center and thus to the desired point of intersection.

FIG. 9 is a detailed perspective view of a cross pin 20 and a view of the cross pin 20 in accordance with the section A-A from FIG. 3, in another modified form. The contact surfaces (recessed surfaces 22) are conical. Both of the parts to be joined are thus forced into the position described in the foregoing.

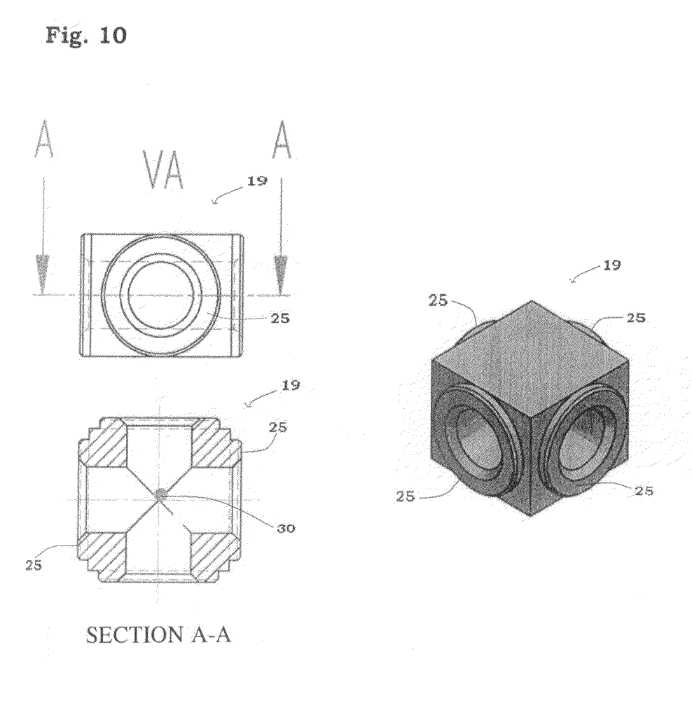

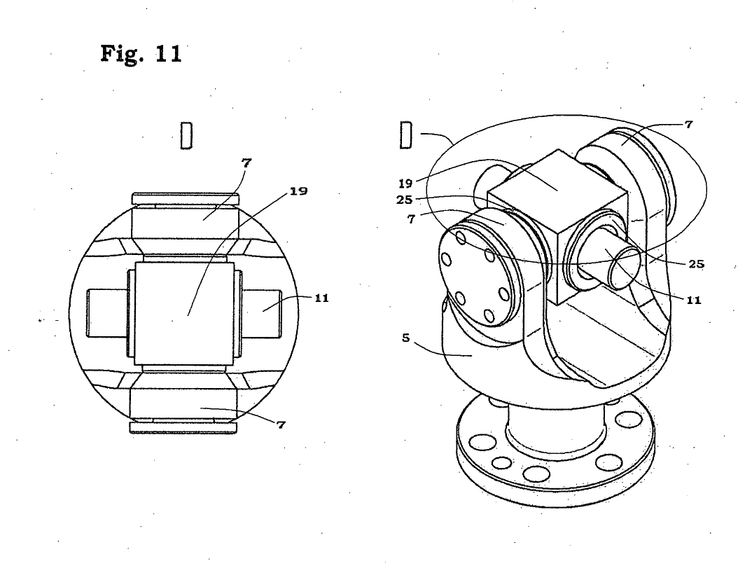

FIG. 10 is a perspective view of a positioning block 19 and sectional drawings of the positioning block 19. The positioning block 19, the material of which is preferably AL (surface hard-coated, anodized, or the like), plastic, ceramic, steel, or the like, represents the critical component between the two joint forks 2 and 5 and the cross pin 20 (FIG. 11). By means of its very precise cross bore 30, the positioning block 19 brings the individual parts of the cross pin 20 into the precisely fitting position. Moreover, its lateral positioning surfaces determine the spacing of the two joint forks 2 and 5 to the axis intersection. The lateral running surfaces (slide surfaces 25) can be finished directly together or can be designed in the form of a plain bearing bush, spring retainer, or axial roller bearing. The systems described in the following can be combined as needed.

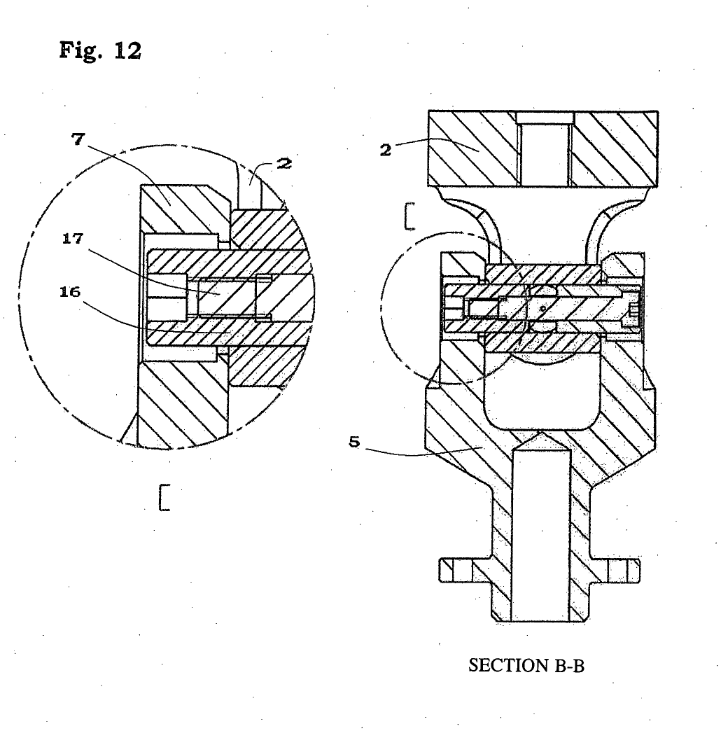

FIG. 12 is a view of an inventive universal joint 1 in accordance with the section B-B from FIG. 3 and a detailed view of a first variant of the installed position of the positioning block 19. The positioning block 19 preferably comprises plastics with a high teflon/graphite content. The contact surfaces on the joint forks are hard-coated so that the forks are free of wear (surface coating especially for high-strength AL alloys). The lateral slide surfaces are preferably made from a solid piece. The advantage of this variant is comprised in simple assembly, large surface-area support and associated lower surface pressure on joint forks 2 and 5, and exact positioning of the joint forks 2 and 5 and of the cross pin 19.

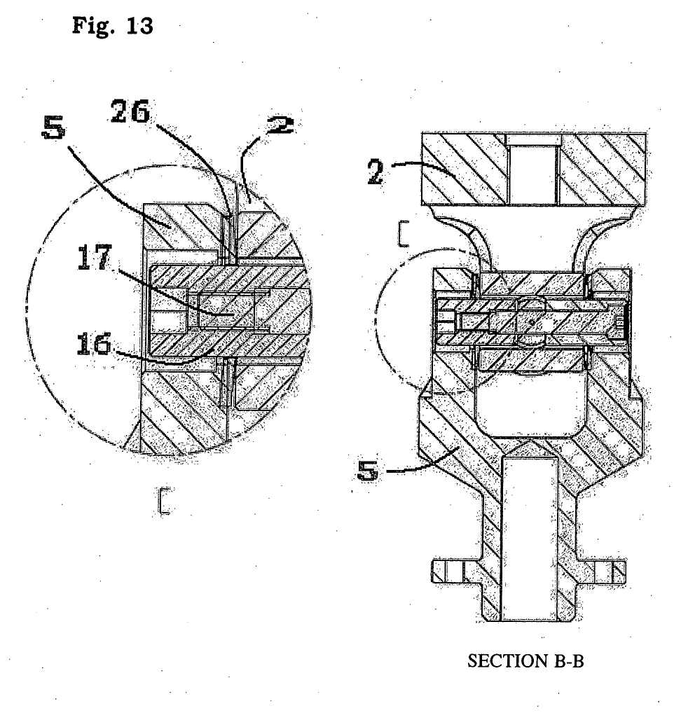

FIG. 13 is a view of an inventive universal joint 1 in accordance with the section B-B from FIG. 3 and a detailed view of a second variant of the installed placement of the positioning block 19. In this, the opportunity is used to design the lateral positioning surfaces in the positioning block 19 as spring retainers 26 to the joint forks 2 and 5. The positioning block 19 is preferably made of an AL alloy with appropriate surface coating. The spring retainer 26, assembled here, preferably comprises a plastic compound containing teflon. However, it would be possible to use other materials if the slide elements were designed accordingly. The advantage of this variant is comprised in a balance of axial play and production tolerances, axial vibration damping, lower surface pressure by the plain bearing, in a cost-effective wear part, in an equal thermal expansion coefficient for the joint fork/positioning block combination, and in simple assembly.

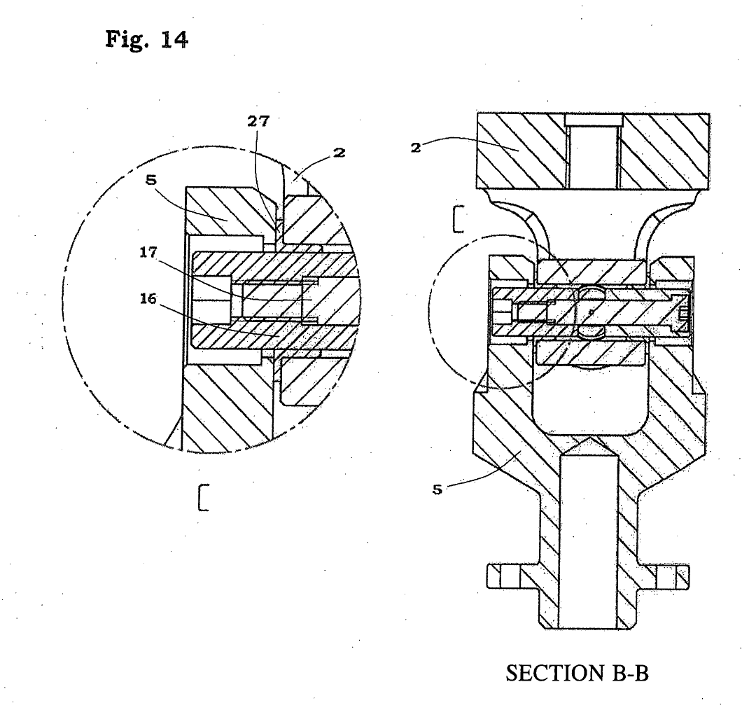

FIG. 14 is a view of an inventive universal joint 1 in accordance with the section B-B from FIG. 3 and a detailed view of a third variant of the installed placement of the positioning block 19. In this case, the bores in the positioning block 19 are designed such that an additional plain bearing bush 27 made of plastic, metal, coating materials, sintered materials, or other coated materials can be pressed in. The bush (plain bearing bush 27) transmits the movement or the forces from the forks 2 and 5 to the positioning block 19 or to the cross pin 20. Thus the bearing bush (plain bearing bush 27) acts both as axial bearing and as radial bearing. The advantage of this variant is comprised in a balance of axial play or production tolerances, axial vibration damping, lower surface pressure by the plain bearing, in a cost-effective wear part, in an equal thermal expansion coefficient for the joint fork/positioning block combination, and in simple assembly.

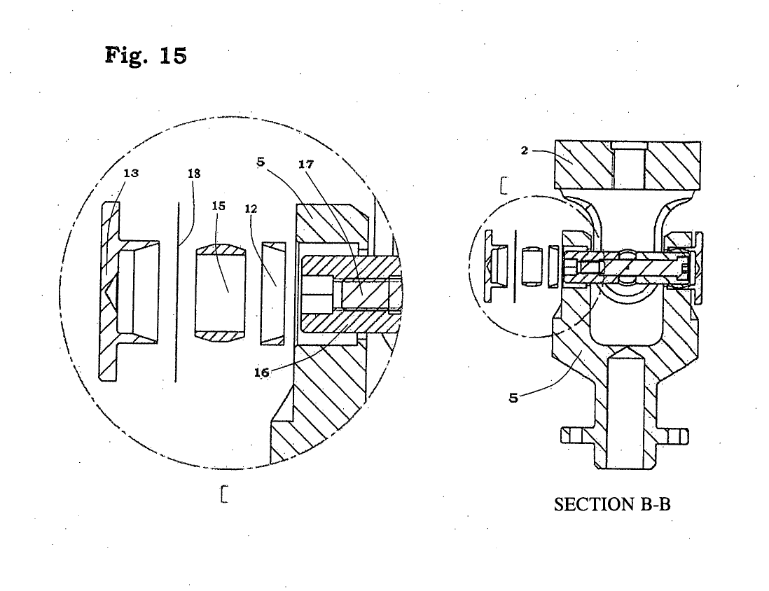

FIG. 15 is a view of an inventive universal joint 1 in accordance with the section B-B from FIG. 3 and a detailed view of a radial bearing of the pins in the joint eyes. This is a plain bearing that has no play, is maintenance-free, and is also somewhat self-adjusting. The combination with conventional roller bearings, in particular small needle bearings, is further possible in this case.

The pressure plate 13, spacer ring (leveling element) 18, conical ring 12, and bearing ring (spring collar 15) represent core elements for the radial bearing.

Screwing the pressure plates 13 to the joint forks 2 and 5 changes the axial spacing of the entire bearing unit. Using the spacer rings 18 it is possible to adjust the bearing prestress and to compensate the wear that occurs with adjustments. The bearing ring (spring collar 15) is clamped between the pressure plate 13 and the conical ring 12 situated in the joint forks 2 and 5. Using the surfaces positioned conically against the components, the interior pressure gauge diameter of the bearing ring is tapered until play in the bearing is no longer possible.

This structure attains the following improvements:
1. Freedom from play;
2. No pressure on surfaces from plain bearing;
3. Very high forces can be transmitted statically;
4. High forces can be transmitted dynamically;
5. Wear compensation possible;
6. Low friction due to optimized material pairings;
7. Vibration damping;
8. High positioning accuracy over extended period;
9. Low mass due to light structural materials; and
10. Cost-effective wear parts.

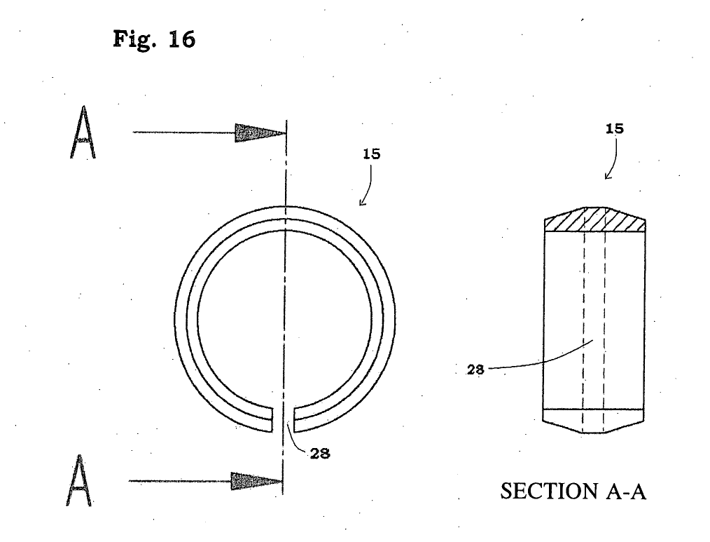

FIG. 16 is sectional depictions of an embodiment variant of the bearing ring (spring collar 15). Since the adjustment when the bearing ring is closed is relatively minor and functions reliably only with relatively elastic materials, it is possible to embody the bearing ring with a slit. The slit substantially increases adjustability since it permits use as a self-adjusting bearing element. Preferably materials such as plastics containing teflon/graphite, ceramic, steel, or coated materials are used.

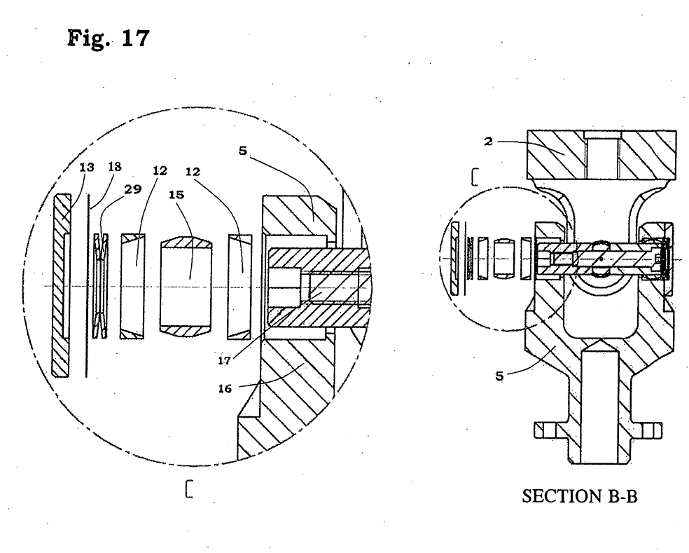

FIG. 17 is a view of an inventive universal joint 1 in accordance with the section B-B from FIG. 3 and a detailed view of a modified radial bearing that is self-adjusting. In order to provide the freedom from play of the inventive universal joint 1 over a prolonged period, the bearing unit is equipped with corresponding spring elements. In this arrangement the play or the wear that occurs is compensated by the interposed spring elements. The spring elements can be embodied as slitted steel spring retainers 29. However, it is also moreover possible to use other spring elements, for instance coil springs, elastomers, or liquid or gas pressures.

The different variants and detailed solutions of the inventive universal joint 1 provide play-free bearing for parallel kinematic applications. The inventive universal joint 1 thereby advantageously satisfied the following requirements:
1. Freedom from play;
2. Freedom from maintenance;
3. Long service life under industrial use conditions;
4. Precise implementation of initiated movement;
5. Avoidance of the stip slick effect;
6. Minimum moved masses;
7. Low interior friction;
8. Balanced stiffness/damping behavior;
9. Cost factors; and
10. Simple assembly.

All of the features depicted in the description, in the following claims, and in the drawing can be essential to the invention, both individually and in any desired combination.

### LEGENDS

Universal joint
First joint fork
Base part
Fork element
Second joint fork
Base part
Fork element
Threaded insert
Flange
Bore
Pin
Bearing ring
Pressure plate
Screw
Spring collar
Sleeve
Screw
Spacer ring
Positioning block
Cross pin
Transverse bore
Recessed surface
Thread
Bolt
Slide surface
Spring retainer
Plain bearing bush
Slit
Steel spring retainer
Cross bore

1. Universal joint comprising a first joint fork having a joint axis and a second joint fork having a joint axis, said joint axes being borne by plain bearings and said joint forks each being formed by a base part and two fork elements, each fork element having a closable bore, said joint axes intersecting between said bores, and a bearing prestress unit which allows said joint fork to move without play about the joint axis thereof.

2. Universal joint in accordance with claim 1, wherein said bearing prestress unit is formed at least by one spring element that acts on the joint axis.

3. Universal joint in accordance with claim 2, wherein and at least one of said bores is closed by a pressure plate that acts on said spring element.

4. Universal joint in accordance with claim 3, comprising a spacer ring arranged between said pressure plate and said base part.

5. Universal joint in accordance with any of claims 2 through 4, wherein said spring element is a spring collar.

6. Universal joint in accordance with any of claims 1 to 4, comprising a positioning block arranged between said bores for positioning said joint axes.

7. Universal joint in accordance with claim 6, wherein said joint axes are borne by a plain bearing in said positioning block.

8. Universal joint in accordance with any of claims 1 to 4, wherein said joint axes are formed by one pin and two sleeves arranged perpendicular thereto.

9. Universal joint in accordance with claim 8, wherein said joint axes are affixed to one another.

10. Universal joint in accordance with claim 9, comprising a screw for affixing said joint axis, said screw being inserted through said sleeves and a bore in said pin.

11. Universal joint in accordance with any of claims 1 to 4, wherein said base part has at least one fastening means on the side facing away from said fork elements.
